(19) United States
(12) Patent Application Publication
(10) Pub. No.: US 2024/0427621 A1
(43) Pub. Date: Dec. 26, 2024

(54) DYNAMIC SIDECAR SIZING AND DEPLOYMENT SYSTEM

(71) Applicant: INTERNATIONAL BUSINESS MACHINES CORPORATION, ARMONK, NY (US)

(72) Inventors: Norman Christopher Böwing, Boeblingen (DE); Simon Daniel Moser, Gärtringen (DE)

(21) Appl. No.: 18/341,017

(22) Filed: Jun. 26, 2023

(51) Int. Cl. G06F 9/455; G06F 9/50

(52) U.S. Cl. CPC G06F 9/45558; G06F 9/5027; G06F 2009/45587

(57) ABSTRACT

An approach is provided for sidecar sizing. An application running in a cluster of a containerized system is provided. The application includes at least one sidecar container having configuration data including a first size of the at least one sidecar container. Requests for the application over time and usage data for the application over time, including memory and/or CPU consumption, are monitored. The first size of the at least one sidecar container is evaluated, and a second size of the least one sidecar container is determined, based on the monitored requests for the application and usage data for the application. Updated configuration data for the at least one sidecar container, including the second size of the at least one sidecar container, is provided.

### BACKGROUND

The present invention relates to sidecar sizing in container systems and more particularly to dynamically sizing a sidecar.

As an overview, a sidecar (or sidecar container) is a type of container that runs alongside a main application container in a containerized application. The sidecar may allow for resource sharing, for example, increased storage volume. Containers are lightweight and portable executable images that contain software and dependencies. Containers may be grouped into units, for example, in Kubernetes® they are known as pods. Typically, each pod runs a single instance of an application and pods may be accessed through a service. Applications, containers, and/or sidecars may run according to saved configuration data, for example, a secret, a ConfigMap, a configuration file, etc. The configuration data may also set a size, size parameters, and the like for the container and/or side container. A container orchestration system automates operations to run containerized applications. For example, the Kubernetes® platform is a portable, extensible, open source platform for container orchestration (i.e., for managing containerized workloads and services). Kubernetes is a registered trademark of The Linux Foundation located in San Francisco, California.

### SUMMARY

In one embodiment, the present invention provides a method. An application running in a cluster of a containerized system is provided. The application includes at least one sidecar container having configuration data including a first size of the at least one sidecar container. Requests for the application over time and usage data for the application over time, including memory and/or CPU consumption, are monitored. The first size of the at least one sidecar container is evaluated, and a second size of the least one sidecar container is determined, based on the monitored requests for the application and usage data for the application. Updated configuration data for the at least one sidecar container, including the second size of the at least one sidecar container, is provided.

A computer program product and a computer system for implementing the method are also described and claimed herein.

### BRIEF DESCRIPTION OF THE DRAWINGS

FIG. 1 is a block diagram of a computer system for sizing a sidecar, in accordance with embodiments of the present invention;

FIG. 2 is a block diagram of modules included in code included in the system of FIG. 1, in accordance with embodiments of the present invention;

FIG. 3a is a block diagram of a system for sizing sidecars, in accordance with embodiments of the present invention;

FIG. 3b is a block diagram of system for sizing sidecars, in accordance with embodiments of the present invention;

FIG. 3c is a block diagram of system for sizing sidecars, in accordance with embodiments of the present invention;

FIG. 3d is a block diagram of system for sizing sidecars, in accordance with embodiments of the present invention;

FIG. 4 is a block diagram of a pod having a main application container and a sidecar container in accordance with embodiments of the present invention;

FIG. 5 is a flowchart of a process of sizing a sidecar, where the operations of the flowchart are performed by the modules in FIG. 2, in accordance with embodiments of the present invention; and

FIG. 6 is a flowchart of a process of sizing a sidecar, where the operations of the flowchart are performed by the modules in FIG. 2, in accordance with embodiments of the present invention.

### DETAILED DESCRIPTION

Sidecar containers are conventionally provided with a predetermined size, i.e., CPU and memory resource amounts. This predetermined size may be set by configuration data, for example, a secret, a ConfigMap, a configuration file, and the like. The predetermined size is often a one-size-fits-all approach deployed globally for all applications, users, regions, etc., for example, by a cloud service provider. Thus, in some situations, sidecars are sized too generously by default and are provided with excess resources in order to ensure adequate functionality for all deployments. In other situations, sidecars are sized too small by default and are only provided with limited resources to avoid containers with excess unused resources but creating the risk that certain applications may be under resourced.

As a more specific example, traffic handling sidecars or traffic handling sidecar containers are also typically deployed globally, for example, by the cloud service provider. The traffic handling sidecars may be overwritten on a per deployment basis but are typically provided with a predetermined size. The resource requirements of traffic handling sidecars will naturally change as the traffic level for the main container application changes; higher traffic will result in the traffic handling sidecar having an increased resource requirement while resource requirements will be vastly decreased during periods with little to no traffic to/from the main container application.

Some conventional approaches to managing resources in pods, containers, and sidecars include vertical pod autoscaling, horizontal pod autoscaling, and cluster autoscaling. Vertical pod autoscaling analyzes CPU and memory resources of containers and increases or decreases allocations/limits as needed. Horizontal pod autoscaling increases or decreases the number of pods (containing multiple containers running replicas) to provide adequate CPU and memory resources. Cluster autoscaling adjusts the number of nodes in the cluster based on workload. These conventional approaches suffer from several drawbacks. For example, the scaled size is environment specific, disruptions may occur as replicas are initiated/terminated, and unnecessary pod churn in the cluster occurs as pods/containers are created and destroyed.

Turning again to the specific example of traffic handling sidecars, the conventional approaches discussed above are not sufficient to address dynamic resource requirements resulting from variable traffic amounts and the same drawbacks will occur. For example, autoscaling may result in a higher resource allocation/limit for a specific environment without accounting for the fact that the traffic handling sidecar will have periods where the higher resource allocation/limit is not needed. Further, disruptions may occur when application traffic transitions from a low traffic period to a high traffic period and additional replicas need to be initiated, and vice versa when application traffic transitions from a high traffic period to a low traffic period and replicas are terminated. Likewise, the cluster may be subject to excessive pod churn as traffic conditions change.

Embodiments of the invention provide for dynamic sizing of sidecar containers and reduce sidecar cluster footprint without causing disruptions or pod churn. Relatedly, embodiments save infrastructure and resources for the cloud provider as sidecars with excessive predetermined sizes are avoided. In fact, in some embodiments savings up of to 50% for reserved CPU and up to 80% on reserved memory may be obtained. Savings are also realized by cloud consumers, as resource provision is optimized for resource consumption thereby avoiding excess cost, on the one hand, or insufficient resource allocation, on the other hand. Still further, embodiments of the invention allow for continuous and dynamic sidecar sizing through an application's lifecycle and without being limited to specific environments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 200 for sidecar sizing. The aforementioned computer code is also referred to herein as computer readable code, computer readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

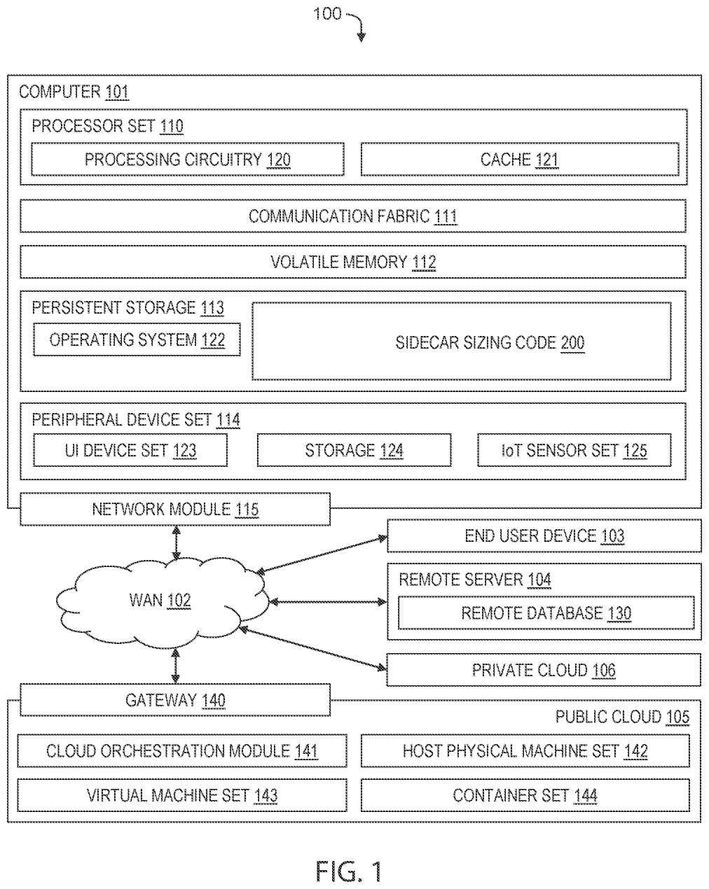

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

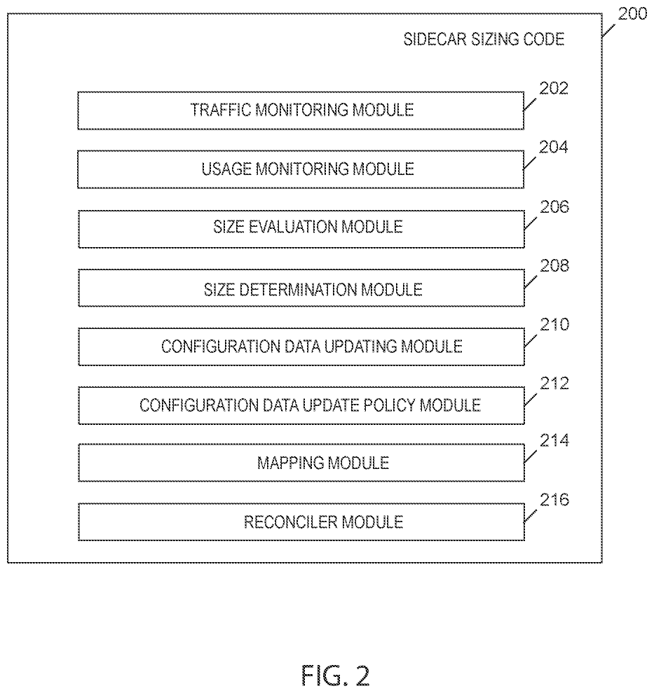

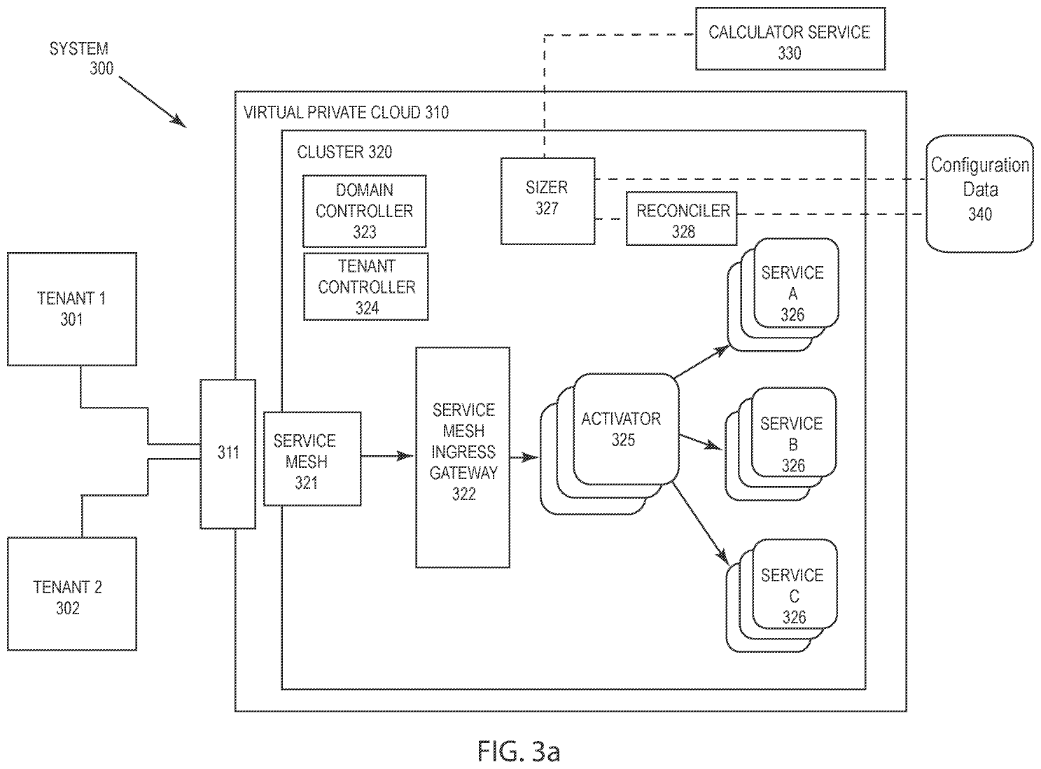

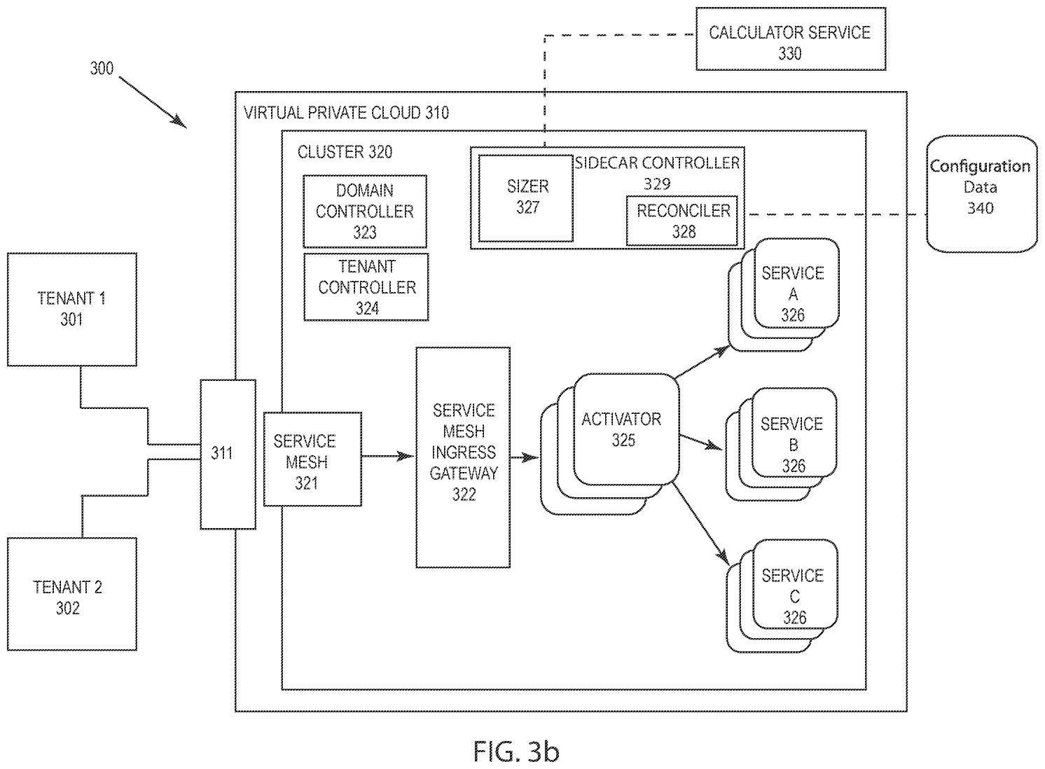

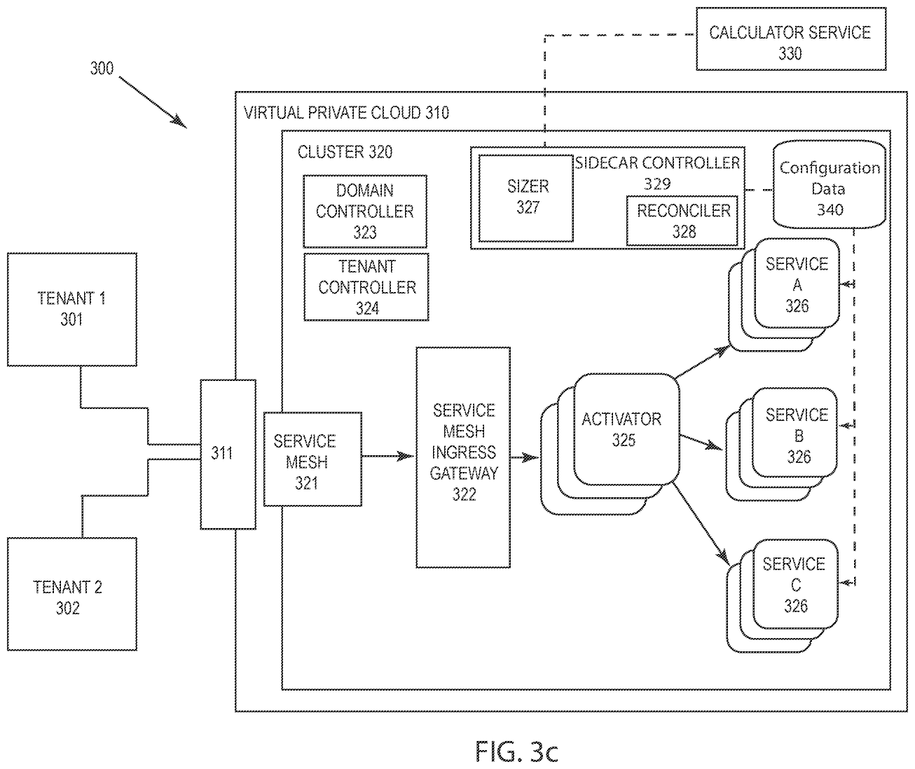

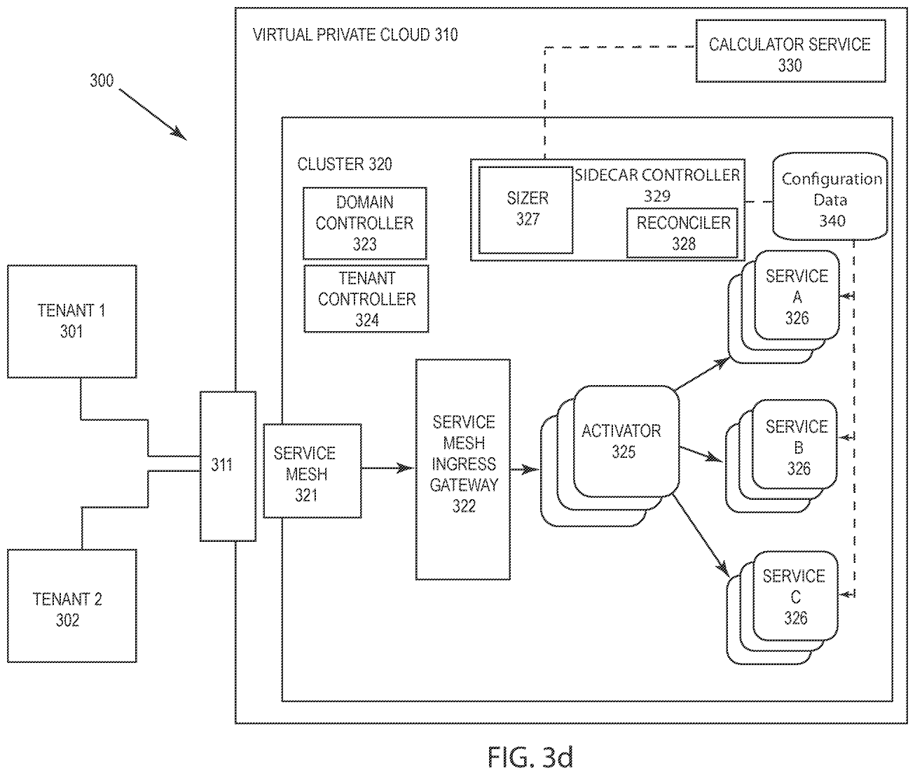

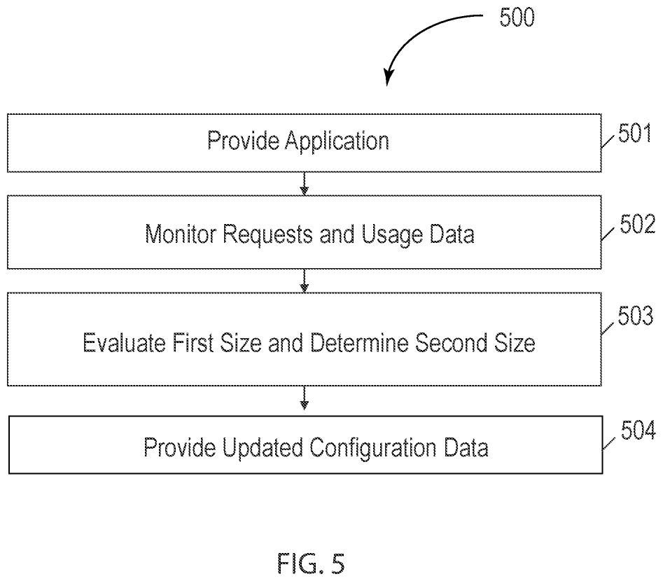

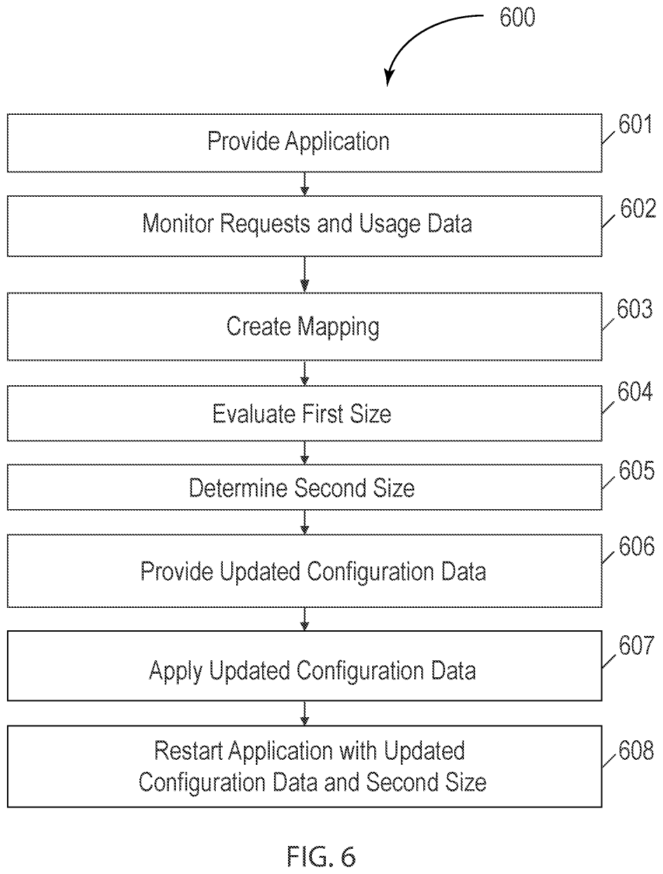

FIG. 2 is a block diagram of modules included in code 200 for sidecar sizing included in the system of FIG. 1, in accordance with embodiments of the present invention. In embodiments, code 200 includes a traffic monitoring module 202, a usage monitoring module 204, a size evaluation module 206, a size determination module 208, a configuration data updating module 210, a configuration data update policy module 212, a mapping module 214, and a reconciler module 216. In embodiments, not all modules may be required and/or additional modules may be provided. The functionality of the modules included in code 200 is discussed in detail in the discussion of the exemplary method flowcharts of FIGS. 5 and 6 discussed in more detail below, as well as to systems such as those discussed in FIGS. 3a-3d.

Before discussing the exemplary method flowcharts, additional detail regarding systems for sidecar sizing is provided in FIGS. 3a-3d. Depicted therein is exemplary system 300. System 300 may be, for example, a container system. In some embodiments, system 300 may be used to provide serverless services, for example, from a cloud service to tenants or users. In the depicted embodiments, system 300 is a multi-tenant container system, providing serverless services to tenant applications such as tenant 1 301 and tenant 2 302. It will be understood that system 300 is not required to be a multi-tenant container system.

System 300 includes a virtual private cloud 310. In embodiments, a load balancer 311 may be included.

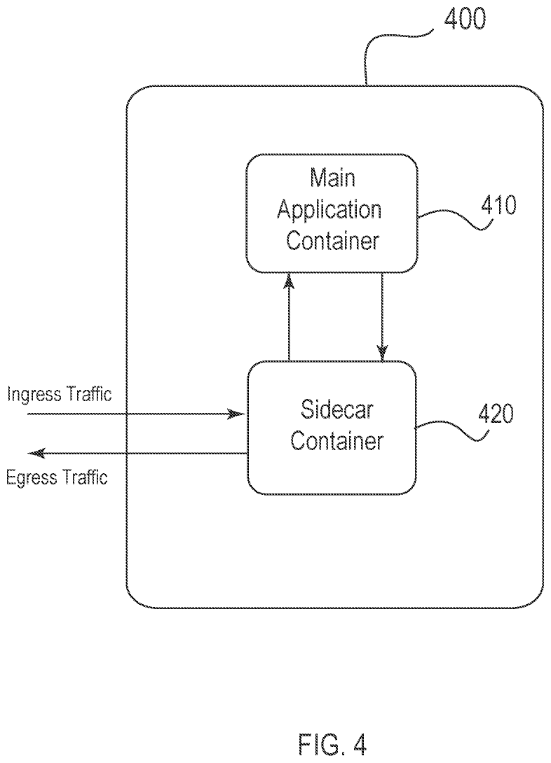

System 300 also includes a cluster 320, for example, a Kubernetes® cluster or other container cluster. The cluster 320 may include one or more services 326, for example, FIGS. 3a-3d depict three services, service A, service B, and service C. At a high level, services 326 are abstractions that allow groups of deployed pods to be exposed. The deployed pods provide an instance of an application and are exposed through an API to the services 326. Thus, the schematic services 326 depicted in FIGS. 3a-3d may be said to comprise one or more pods, one or more instances of an application, and one or more API paths. Likewise, the schematic services 326 depicted in FIGS. 3a-3d may be said to comprise one or more containers and one or more sidecars. The containers and sidecars are not separately depicted in FIGS. 3a-3d; however, FIG. 4 depicts a schematic view of an exemplary pod 400 having a main application container 410 and a sidecar container 420. As depicted therein, the sidecar container 420 is a traffic handling sidecar handing incoming/outgoing requests, i.e., ingress traffic and egress traffic. In embodiments, the pod 400 may have multiple main application containers (not depicted).

Referring again to FIGS. 3a-3d, configuration data, such as configuration data 340 depicted in the figures, may be associated with the containers and with the sidecars of the services 326 (for example with the sidecar container 420 depicted in FIG. 4). As discussed above, configuration data may be used to store information to be consumed by containers, including configuration parameters, configuration settings, and the like for the container and/or for the sidecar of the services 326.

The cluster 320 may also include a domain controller 323, tenant controller 324, as well as other components known to be used in systems such as containerized systems. Still further, the cluster 320 may include a service mesh 321, for example, an Istio® service mesh. Istio is a registered trademark of The Linux Foundation located in San Francisco, California. Traffic into the cluster 320 may be routed by the service mesh 321, for example, using a service mesh ingress gateway 322. In embodiments, traffic may be provided to an activator 325. The activator 325 may activate or turn on specific services 326 in the cluster 320.

Still further, in embodiments the cluster 320 includes a sizer 327. As explained in more detail below, the sizer 327 monitors and/or evaluates sidecar size of a sidecar of the service over time. In embodiments, the cluster 320 also includes a reconciler 328. As explained in more detail below, the reconciler 328 may be triggered to update sidecar size as part of embodiments of the invention. In some embodiments, the sizer 327 and reconciler 328 may be provided as part of a sidecar controller 329 as depicted in FIGS. 3b-3d. The sidecar controller 329 may serve to monitor, evaluate, and update sidecar container size as needed in accordance with embodiments discussed herein.

Embodiments of the invention and of system 300 further include a calculator service 330. In embodiments, the calculator service may be provided separately from, or outside of, the cluster 320 and/or the virtual private cloud 310. For example, as shown in FIGS. 3a-3c, the calculator service 330 may be outside the architecture of the cluster 320 and/or the virtual private cloud 310. As an example, in embodiments a single global calculator service may be provided for the entire virtual private cloud 310, for an entire cluster 320, for multiple clusters, etc. In other embodiments, the calculator service 330 may be a part of the virtual private cloud 310 as shown in FIG. 3d or may be a part of the cluster 320 (not depicted).

Exemplary functions of the system 300 in accordance with embodiments will now be described. Traffic requests to and from the cluster 320 are monitored over time. For example, in embodiments, the traffic requests may be monitored by the service mesh 321, the sizer 327, the sidecar controller 329, and/or other components of the cluster 320. The monitoring includes which API paths of the application the requests are associated with and/or routed to, for example, within respective service(s) 326.

Further, CPU and memory usage are monitored over time and may be referred to jointly as usage data. For example, in embodiments, CPU and memory usage may be monitored by the service mesh 321, the sizer 327, the sidecar controller 329, and/or other components of the cluster 320. CPU and memory usage may be monitored for individual sidecar containers (such as sidecar container 420), individual containers (such as main application container 410), applications, API paths, pods, services, etc.

In embodiments, the system 300, for example, the sizer 327 or other component, may create a mapping of the traffic requests for each API path with CPU and memory usage. For example, when traffic requests and CPU and memory usage are monitored at the API path level, the mapping may be as follows:

$$\sum {API}_{path} ( CPU , mem ) ( API\_path ) = req / consumed\_resources * weight .$$

As evident from the exemplary mapping, resource consumption may change as an application changes or is updated.

Still further, in embodiments, the system 300, for example, the sizer 327, sidecar controller, and/or the calculator service 330, may predict expected traffic requests, for example, to/from a service 326, an application, an API path, a pod, a container, a sidecar container, etc., and/or may predict CPU and memory usage. Various prediction methods may be used in embodiments. As examples, user-driven interactions with a service 326, an application, and/or an API path often follow patterns that can be predicted, allowing for prediction of traffic requests and CPU and memory usage. Likewise, path-based processes may be predictable in similar manner, with additional emphasis on differential CPU and memory usage requirements for different path options. Still further, time-based predictions, stochastic predictions, and the like may be used to predict traffic requests and/or CPU and memory usage over time.

As discussed above, in embodiments predictions may be environment-agnostic, i.e., the predictions may not require the same environment to be valid or applicable, may not be limited to a single environment, etc. As an example, predictions may be valid even when different CPU architectures are used, may be valid across different regions, and the like.

Based on the predicted traffic requests and/or CPU and memory usage and/or the mapping, the sizer 327, or sidecar controller 329, may use the calculator service 330 to evaluate the sidecar container size, for example, parameters of the sidecar size. For example, a first size of the sidecar container may be evaluated. The first size may refer to an existing size of the sidecar container, for example, a default size, a predetermined size, an original deployment size, and the like. The first size may also refer to the existing configuration data setting the size, configuration parameters, configuration settings, and the like. The first size of the sidecar container may be evaluated against traffic requests, predicted traffic requests, CPU and memory usage, predicted CPU and memory usage, the mapping, and combinations thereof.

In embodiments, calculator service 330 calculates a result that represents a second or updated size of the sidecar. The second or updated size of the sidecar may reflect a required or optimized size of the side car, for example, updated parameters of sidecar size, based on the traffic requests, predicted traffic requests, CPU and memory usage, predicted CPU and memory usage, the mapping, and combinations thereof. Further, referring again to the mapping, the calculator service 330 may have the option to modify the variables #req and weight depending on what prediction mechanism is used and/or on individual settings for the tenant, service, application, API path, container, sidecar, etc.

The second or updated size of the sidecar, for example, the parameters of sidecar size, may be stored in updated configuration data for the sidecar. Thus, the configuration data, configuration parameters, configuration settings, and the like are updated. In embodiments, the result representing the second or updated size of the sidecar, the updated parameters of sidecar size, and/or the second or updated size of the sidecar may be provided to the sizer 327, the reconciler 328, and/or the sidecar controller 329. In further embodiments, the result representing the second or updated size of the sidecar, the updated parameters of sidecar size, and/or the second or updated size of the sidecar may be provided to the services 326, the application, the pod, and/or the sidecar container in some other way.

The updated configuration data for the sidecar may then be applied. For example, in embodiments, the reconciler 328 may be triggered to read the updated configuration data and translate the second or updated size of the sidecar into a proper format for the sidecar, for example, depending on a type of the sidecar container 420.

As an example, the reconciler 328 may translate the second or updated size and set annotations such as the following example:
sidecar.istio.io/proxyCPU: 200 m
sidecar.istio.io/proxyMemory: 512M
queue.sidecar.serving.knative.dev/resourcePercentage

In embodiments, the reconciler 328 may be triggered based on any change in the size or parameters of sidecar size. In other embodiments, the reconciler 328 may be triggered when the second or updated size of the sidecar differs from the first size by a certain amount, for example, when a threshold is exceeded. In still further embodiments, the reconciler 328 may be triggered based on an update policy. For example, the update policy may set a required difference between sizes that must be met for the reconciler 328 to be triggered, may provide other criteria to be met in order for the reconciler 328 to be triggered, may provide a schedule for triggering the reconciler, etc. In embodiments, the second or updated size may be applied upon a restart of the application and/or upon initiation of a new instance of the application, for example, may be applied automatically in response to these events.

As discussed above, system 300 may provide serverless services to tenant applications. In embodiments where in the system 300 is providing serverless services, the services 326 may frequently scale to and from zero activity. For example, there may be times with little to no incoming/outgoing requests for the services 326 and/or the application. As an example, some applications may receive traffic primarily during business hours but not overnight, some applications may be seasonal or have activity dependent on scheduled events, and the like. Embodiments of the current invention allow for scaling down to zero or close thereto, for example, scaling sidecar container size, CPU and memory allocation, etc. down to a minimal amount. During such times, the application or API end point may be thought of as being shut off, hibernating, sleeping, or the like. Even when not scaled entirely to zero, the sidecar may be sized as small as possible without interfering with workload. This allows a reduced cluster footprint and provides both the cloud provider and the cloud consumer with savings as discussed above.

Based on resumed or increased traffic, the application or API end point may be thought of as turned back on, woken up, or the like. During this time, the sidecar container size, CPU and memory allocation, etc. may be scaled back up from zero using the processes described herein.

Thus, embodiments of the invention allow for dynamic changes to sidecar size that can be easily implemented, for example, using a “lazy” approach.

FIG. 5 is a flowchart of an exemplary process of sizing a sidecar container in accordance with embodiments of the present invention. In embodiments, some or all of the operations of the flowchart may be performed by the modules in FIG. 2 and/or by components shown in FIGS. 3a-3d.

In step 501, an application is provided. The application may run in a cluster of a containerized system, for example, cluster 320 of system 300. For example, the application may be run in a pod such as pod 400 of FIG. 4. The application may include at least one main application container such as main application container 410 and may include at least one sidecar container such as sidecar container 420. The at least one sidecar container may have configuration data such as configuration data 340. In embodiments, providing the application may include deploying the application, starting the application, restarting the application, and the like. In embodiments, the application may be deployed, started, or restarted with the at least one sidecar container having a default size.

In step 502, incoming/outgoing requests for the application and usage data for the application are monitored. For example, a traffic monitoring module such as traffic monitoring module 202 may monitor incoming/outgoing requests for an API path of an application and a usage monitoring module such as usage monitoring module 204 may monitor usage data. Usage data may include memory and/or CPU consumption. The incoming/outgoing requests and usage data may be monitored over time. Further, the incoming/outgoing requests may be associated with a specific API path or specific API paths, for example, of an application or multiple applications.

In step 503, a first size (for example, the default size) of the at least one sidecar container may be evaluated and a second size (for example, an updated size) of the at least one sidecar container may be determined. For example, in embodiments the first size of the at least one sidecar container may be evaluated by a size evaluation module such as size evaluation module 206 and the second size of the at least one sidecar container may be determined by a size determination module such as size determination module 208. In embodiments, the evaluating, determining, or both may be based on incoming/outgoing requests for the application as well as usage data for the application. For example, the usage data may include memory and/or CPU consumption as discussed above.

In step 504, updated configuration data may be provided for the at least one sidecar container. For example, the updated configuration data may be provided by a configuration data updating module such as configuration data updating module 210. The updated configuration data may include the determined second size of the at least one sidecar container. In embodiments, the updated configuration data may be provided to a reconciler such as reconciler 328 and used by the reconciler to adjust the size of the at least one sidecar container.

The updated configuration data thus includes updated size parameters for the at least one sidecar container. Accordingly, the at least one sidecar container is provided with a second or updated size as discussed above. The second or updated size may be applied to the at least one sidecar container at an appropriate time.

FIG. 6 is a flowchart of another exemplary process of sizing a sidecar container in accordance with embodiments of the present invention. In embodiments, some or all of the operations of the flowchart may be performed by the modules in FIG. 2 and/or by components shown in FIGS. 3a-3d.

In step 601, an application is provided. Like the embodiment of FIG. 5, the application may run in a cluster of a containerized system, for example, cluster 320 of system 300. For example, the application may be run in a pod such as pod 400. The application may include at least one main application container such as main application container 410 and may include at least one sidecar container such as sidecar container 420. The at least one sidecar container may have configuration data such as configuration data 340. In embodiments, providing the application may include deploying the application, starting the application, restarting the application, and the like. In embodiments, the application may be deployed, started, or restarted with the at least one sidecar container having a default size.

In step 602, incoming/outgoing requests for the application and usage data for the application are monitored. For example, a traffic monitoring module such as traffic monitoring module 202 may monitor incoming/outgoing requests for an API path of an application and a usage monitoring module such as usage monitoring module 204 may monitor usage data. Usage data may include memory and/or CPU consumption. The incoming/outgoing requests and usage data may be monitored over time. Further, the incoming/outgoing requests may be associated with a specific API path or specific API paths, for example, of an application or multiple applications.

In step 603, a mapping is created for the incoming/outgoing requests for the application and the usage data for the application. For example, a mapping module such as a mapping module 214 may create the mapping. As discussed above, the mapping may link the incoming/outgoing requests with memory/CPU consumption over time or otherwise capture the relationship between these. In embodiments, the mapping may use the following general equation:

$$\sum {API}_{path} ( CPU , mem ) ( AP1\_path ) = req / consumed\_resources * weight .$$

In step 604, a first size (for example, the default size) of the at least one sidecar container may be evaluated. For example, in embodiments the first size of the at least one sidecar container may be evaluated by a size evaluation module such as size evaluation module 206. In embodiments, the evaluating may be based on incoming/outgoing requests for the application as well as usage data for the application; for example, based on the mapping. This evaluation may include analysis of predicted traffic, i.e., predicted incoming/outgoing requests for a current or upcoming time, and/or predicted memory/CPU requirements.

In step 605, a second size (for example, an updated size) of the at least one sidecar container may be determined. For example, in embodiments the second size of the at least one sidecar container may be determined by a size determination module such as size determination module 208. In embodiments, the determining may be based on incoming/outgoing requests for the application as well as usage data for the application; for example, based on the mapping. This determination may include analysis of predicted traffic, i.e., predicted incoming/outgoing requests for a current or upcoming time, and/or predicted memory/CPU requirements.

In step 606, updated configuration data may be provided for the at least one sidecar container. For example, the updated configuration data may be provided by a configuration data updating module such as configuration data updating module 210. The updated configuration data may include the determined second size of the at least one sidecar container. In embodiments, the updated configuration data may be provided to a reconciler such as reconciler 328 and used by the reconciler to adjust the size of the at least one sidecar container.

In step 607, the updated configuration data may be applied. In embodiments, the updated configuration data may be applied by the reconciler 328 and/or by a reconciler module such as reconciler module 216. In embodiments, the application may retrieve and apply the updated configuration data and/or may be directed to retrieve and apply the updated configuration data. Still further, in some embodiments, the updated configuration data may be applied, for example, by the reconciler, based on a configuration data update policy. For example, the configuration data update policy may set a required difference between sizes that must be met, may provide other criteria to be met, and/or may provide a schedule that must be met for the updated configuration data to be applied. In embodiments, the configuration data update policy may be provided by or stored by a configuration data update policy module such as configuration data update policy module 212. In some embodiments, the updated configuration data may be applied upon subsequent start or restart of the application and/or upon initiation of a new instance of the application. For example, in optional step 608 the application may be restarted with the updated configuration data and second size.

The described methods, including the flowcharts of FIGS. 5 and 6, illustrate possible implementations of methods for sizing a sidecar container according to embodiments of the invention. In alternative embodiments, the steps noted may occur out of the order noted. For example, steps described or shown in succession may be accomplished as one step, executed concurrently, substantially concurrently, in a partially or wholly temporally overlapping manner, may sometimes be executed in an alternate order or even reverse order, or may be omitted. Still further, additional steps may be included or steps from one depicted method may be applied to another depicted method.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
providing an application running in a cluster of a containerized system, wherein the application includes at least one sidecar container, and wherein the at least one sidecar container has configuration data including a first size of the at least one sidecar container;
monitoring requests for the application over time and usage data for the application over time, wherein the usage data includes memory and/or CPU consumption;
evaluating the first size of the at least one sidecar container and determining a second size of the least one sidecar container, based on the monitored requests for the application and usage data for the application; and
providing updated configuration data for the at least one sidecar container, wherein the updated configuration data includes the second size of the at least one sidecar container.

2. The method of claim 1, further comprising:
creating a mapping of the requests for the application over time and the usage data for the application over time.

3. The method of claim 1, further comprising:
directing the application to retrieve and apply the updated configuration data.

4. The method of claim 1, further comprising:
associating the monitored requests with at least one API path of the application.

5. The method of claim 1, further comprising:
providing the updated configuration data to a reconciler of the cluster of the containerized system.

6. The method of claim 1, further comprising:
applying the updated configuration data in response to an action selected from the group consisting of a subsequent start of the application, a restart of the application, and a configuration data update policy being met.

7. The method of claim 1, wherein the containerized system provides serverless services to multiple tenants and/or wherein the at least one sidecar container is a traffic handling sidecar container.

8. A system comprising:
one or more computer processors;
one or more computer readable storage media; and
computer readable code stored collectively in the one or more computer readable storage media, with the computer readable code including data and instructions to cause the one or more computer processors to perform at least the following operations:
providing an application running in a cluster of a containerized system, wherein the application includes at least one sidecar container, and wherein the at least one sidecar container has configuration data including a first size of the at least one sidecar container;
monitoring requests for the application over time and usage data for the application over time, wherein the usage data includes memory and/or CPU consumption;
evaluating the first size of the at least one sidecar container and determining a second size of the least one sidecar container, based on the monitored requests for the application and usage data for the application; and
providing updated configuration data for the at least one sidecar container, wherein the updated configuration data includes the second size of the at least one sidecar container.

9. The system of claim 8, further comprising:
creating a mapping of the requests for the application over time and the usage data for the application over time.

10. The system of claim 8, further comprising:
directing the application to retrieve and apply the updated configuration data.

11. The system of claim 8, further comprising:
associating the monitored requests with at least one API path of the application.

12. The system of claim 8, further comprising:
providing the updated configuration data to a reconciler of the cluster of the containerized system.

13. The system of claim 8, further comprising:
applying the updated configuration data in response to an action selected from the group consisting of a subsequent start of the application, a restart of the application, and a configuration data update policy being met.

14. The system of claim 8, wherein the containerized system provides serverless services to multiple tenants and/or wherein the at least one sidecar container is a traffic handling sidecar container.

15. A computer program product comprising:
one or more computer readable storage media having computer readable program code collectively stored on the one or more computer readable storage media, the computer readable program code being executed by one or more processors of a computer system to cause the computer system to perform at least the following operations:
providing an application running in a cluster of a containerized system, wherein the application includes at least one sidecar container, and wherein the at least one sidecar container has configuration data including a first size of the at least one sidecar container;
monitoring requests for the application over time and usage data for the application over time, wherein the usage data includes memory and/or CPU consumption;
evaluating the first size of the at least one sidecar container and determining a second size of the least one sidecar container, based on the monitored requests for the application and usage data for the application; and
providing updated configuration data for the at least one sidecar container, wherein the updated configuration data includes the second size of the at least one sidecar container.

16. The computer program product of claim 15, further comprising:
creating a mapping of the requests for the application over time and the usage data for the application over time and/or associating the monitored requests with at least one API path of the application.

17. The computer program product of claim 15, further comprising:
directing the application to retrieve and apply the updated configuration data.

18. The computer program product of claim 15, further comprising:
providing the updated configuration data to a reconciler of the cluster of the containerized system.

19. The computer program product of claim 15, further comprising:
applying the updated configuration data in response to an action selected from the group consisting of a subsequent start of the application, a restart of the application, and a configuration data update policy being met.

20. The computer program product of claim 15, wherein the containerized system provides serverless services to multiple tenants and/or wherein the at least one sidecar container is a traffic handling sidecar container.
